(19) United States
(12) Patent Application Publication
(10) Pub. No.: US 2008/0066571 A1
(43) Pub. Date: Mar. 20, 2008

(54) Shifting apparatus for transmission

(75) Inventors: Masaki Kawamoto, Nishio-shi (JP); Shiro Ogami, Kariya-shi (JP); Yuichi Fukuhara, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI Co., Ltd., Nishio-shi (JP)

(21) Appl. No.: 11/902,043

(22) Filed: Sep. 18, 2007

(30) Foreign Application Priority Data
Sep. 19, 2006 (JP) 2006-252330

(51) Int. Cl. B60K 20/02; G05G 9/00

(52) U.S. Cl. 74/473.1

(57) ABSTRACT

A shifting apparatus for a transmission includes a shift-and-select shaft, a retaining member, at least one shifting member rotatably and slidably supported by the shaft to be in contact with an axial end of the retaining member, plural driving pins, plural neutral interlock grooves formed at outer plan surfaces of the retaining member to be slidably engaged with the driving pins, plural shifting interlock grooves, a stepped recessed-portion formed at one of outer plan surfaces of the shifting member, and plural non-shifting grooves formed at the other outer plan surfaces of the shifting member. The shifting member is rotated and detected in a selected position relative to the retaining member. Then, the retaining member and the shifting member are reciprocated so that one of the driving pins makes a contact with the shifting inclined surface of the shifting member and the fork shaft is reciprocated.

### CROSS REFERENCE TO RELATED APPLICATIONS

This application is based on and claims priority under 35 U.S.C. § 119 to Japanese Patent Application 2006-252330, filed on Sep. 19, 2006, the entire content of which is incorporated herein by reference.

### FIELD OF THE INVENTION

The present invention relates to a shifting apparatus for a transmission. The shifting apparatus selectively shifts multiple gear stages, for transmitting a torque for a vehicle such as an automobile, by means of a plurality of shift forks supported to be axially movable. More specifically, the present invention relates to a shifting apparatus for a transmission, a shifting apparatus which is suitable for automating the transmission mounted on a vehicle.

### BACKGROUND

An automated manual transmission for a vehicle such as an automobile has been proposed, which is structured based upon a gear-type manual transmission and is automatically operated. As one of the example of the automated manual transmission, an automatic operating mechanism for a transmission is disclosed in a Japanese Patent No. S64(1988)-46046A (hereinafter, referred to as reference 1). The automatic operating mechanism disclosed in the reference 1 includes a cylindrical cam rotated by a motor, a cylindrical cam of which outer periphery is formed with plural cam grooves. Further, according to the automatic operating mechanism in the reference 1, shift forks for shifting gears of the transmission are partially engaged with the cam grooves to be reciprocated, respectively. The shift forks are mutually associated with each other when the cylindrical cam is rotated by the motor. Therefore, when one of the shift forks is driven by the motor, the others are stopped at a neutral position. Accordingly, a shift operation is implemented in the transmission with the multiple shift forks being operatively associated with each other. This known work is applicable not only when a speed changing is automatically performed with a motor which is controlled on the basis of a speed-change command in accordance with an operating condition of the vehicle such as an automobile etc., but also when a speed changing is manually performed.

According to the above described known work, however, flexed and complicated shaped cam grooves are required to be formed at the outer periphery of the cylindrical cam in accordance with a shifting pattern. Accordingly, manufacturing process may require more man-hours and manufacturing cost may be increased.

A need thus exists for a sifting mechanism for a transmission which is not susceptible to the drawback mentioned above.

### SUMMARY OF THE INVENTION

According to an aspect of the present invention, a shifting apparatus for a transmission have a plurality of rotational shafts, a plurality of sets of speed change gears mounted on the rotational shafts, a shift fork which is movable in parallel with the rotational shafts, a sleeve arranged between the adjacent sets of speed change gears and operated by the shift fork to connect one of the adjacent sets of speed change gears with the corresponding rotational shaft, so that a driving force transmitting path is established in the transmission with one of the sets of speed change gears selectively shifted in response to a movement of the shift fork and the operation of the sleeve. According to the shifting apparatus for the transmission, the shifting apparatus includes a shift-and-select shaft, a retaining member, at least one shifting member, a plurality of driving pins, a plurality of neutral interlock grooves, a plurality of shifting interlock grooves, a stepped recessed-portion, and a plurality of non-shifting grooves. The shift-and-select shaft is supported by a supporting member and is arranged in perpendicular with the rotational shafts of the transmission. Further, the shift-and-select shaft is rotatable by an actuation of a selecting actuator and is reciprocable in an axial direction by an actuation of a shifting actuator. The retaining member is formed by a board member with a regular polygon in cross section and has a plurality of outer plan surfaces which is parallel with an axial line of the shift-and-select shaft. Further, the retaining member is coaxially and rotatably supported by the shift-and-select shaft and to be limitedly slidable in the axial direction. Still further, the retaining member is arranged to be restricted from a relative rotation with the supporting member. The shifting member is formed by a board member with a regular polygon in cross section which is identical with the regular polygon in the cross section of the retaining member. Further, the board member has a plurality of outer plan surfaces which is parallel with the axial line, and is fixedly supported by the shift-and-select shaft to be rotatable and slidable therewith and to be in contact with an axial end surface of the retaining member. The driving pins are connected to the plurality of shift forks, respectively, for moving the plurality of shift forks in a direction being parallel with the plurality of rotating shafts of the transmission. The neutral interlock grooves are formed to be slidably engaged with the plurality of driving pins, and are formed at intermediate portions of the outer plan surfaces of the retaining member, respectively. Further, the neutral interlock grooves extend over an entire length in a thickness direction of the retaining member to be in parallel with the axial line of the shift-and-select shaft. The shifting interlock grooves are formed adjacent to the plurality of neutral interlock grooves respectively, with a predetermined distance. Further, the shifting interlock grooves extend over the entire length in the thickness direction of the retaining member to be in parallel with the axial line of the shift-and-select shaft, and a shape of the shifting interlock grooves is identical with a shape of the neutral interlock grooves, respectively. The stepped recessed-portion is formed at one of the outer plan surface of the shifting member. Further, the stepped recessed-portion includes a shifting inclined surface which faces the axial end surface of the retaining member, and inclines relative to the axial end surface of the retaining member in a radial direction. The non-shifting grooves are formed at the other outer plan surfaces of the shifting member, and are arranged to be continuous with the neutral interlock grooves and shifting interlock grooves of the retaining member, when the shifting member is arranged to be coplanar with the outer plan surfaces of the retaining member. According to the shifting apparatus for the transmission, the shifting member is rotated by the selecting actuator via the shift-and-select shaft and is sequentially detected in a position where the outer plan surfaces of the shifting member are arranged to be coplanar with the outer plan surfaces of the retaining member respectively. The retaining member and the shifting member are reciprocated in the axial direction by the shifting actuator via the shift-and-select shaft upon a detected condition. The plural sets of speed change gears are selectively shifted by retaining the driving pin which is retained in the neutral interlock groove facing the outer plan surface of the shifting member formed with the stepped-recessed portion in the shifting interlock groove of the retaining member, after contacting the driving pin with the shifting inclined surface of the stepped recessed-portion and moving the driving pin with the corresponding shift fork.

### BRIEF DESCRIPTION OF THE DRAWINGS

The foregoing and additional features and characteristics of the present invention will become more apparent from the following detailed description considered with reference to the accompanying drawings, wherein:

FIG. 1 is a plan view illustrating an overall structure of a shifting apparatus for a transmission according to a first embodiment;

FIG. 2 is an exploded perspective view illustrating a retaining member and shifting members, which are main portions of the shifting apparatus for the transmission according to the first embodiment;

FIG. 3 is an enlarged cross sectional view of the shifting apparatus for the transmission taken along line III-III in FIG. 1;

FIG. 4 is a right side view of the shifting apparatus for the transmission in FIG. 3;

FIG. 5 is a skeleton diagram illustrating a structure of the transmission which the shifting apparatus for the transmission according to the first embodiment is adapted to;

FIGS. 6A1 to 6A4 are partial plan views of the retaining member and the shifting members when operated for first speed driving and for reverse driving according to the first embodiment, illustrated as seen from directions of four outer plan surfaces of the retaining member;

FIGS. 6B1 to 6B4 are partial plan views of the retaining member and the shifting members when operated for second speed driving and for third speed driving according to the first embodiment, illustrated as seen from the directions of the four outer plan surfaces of the retaining member;

FIGS. 6C1 to 6C4 are partial plan views of the retaining member and the shifting members when operated for fourth speed driving and for fifth speed driving according to the first embodiment, illustrated as seen from the directions of the four outer plan surfaces of the retaining member;

FIGS. 6D1 to 6D4 are partial plan views of the retaining member and the shifting members when operated for sixth speed driving and for seventh speed driving according to the first embodiment, illustrated as seen from the directions of the four outer plan surfaces of the retaining member;

FIG. 7 is an exploded perspective view illustrating a retaining member and shifting members, which are main portions of a shifting apparatus for a transmission according to a second embodiment;

FIG. 8 is a skeleton diagram illustrating a structure of the transmission which the shifting apparatus for the transmission according to the second embodiment is adapted to;

FIG. 9A1 to 9A4 are partial plan views of the retaining member and the shifting members when operated for forming a first shift stage and a second shift stage according to the second embodiment, illustrated as seen from the directions of the four outer plan surfaces of the retaining member;

FIG. 9B1 to 9B4 are partial plan views of the retaining member and the shifting members when operated for forming a third shift stage according to the second embodiment, illustrated as seen from the directions of the four outer plan surfaces of the retaining member;

FIG. 9C1 to 9C4 are partial plan views of the retaining member and the shifting members when operated for forming a fourth shift stage according to the second embodiment, illustrated as seen from the directions of the four outer plan surfaces of the retaining member;

FIG. 9D1 to D4 are partial plan views of the retaining member and the shifting members when operated for resetting the third shift stage and the fourth shift stage according to the second embodiment, illustrated as seen from the directions of the four outer plan surfaces of the retaining member;

FIG. 10E1 to 10E4 are partial plan views of the retaining member and the shifting members when operated for forming a fifth shift stage and a sixth shift stage according to the second embodiment, illustrated as seen from the directions of the four outer plan surfaces of the retaining member;

FIG. 10F1 to 10F4 are partial plan views of the retaining member and the shifting members when operated for forming a seventh shift stage according to the second embodiment, illustrated as seen from the directions of the four outer plan surfaces of the retaining member;

FIG. 10G1 to 10G4 are partial plan views of the retaining member and the shifting members when operated for forming a reverse shift stage according to the second embodiment, illustrated as seen from the directions of the four outer plan surfaces of the retaining member; and

FIG. 10H1 to 10H4 are partial plan views of the retaining member and the shifting members when operated for resetting the reverse shift stage according to the second embodiment, illustrated as seen from the directions of the four outer plan surfaces of the retaining member.

### DETAILED DESCRIPTION

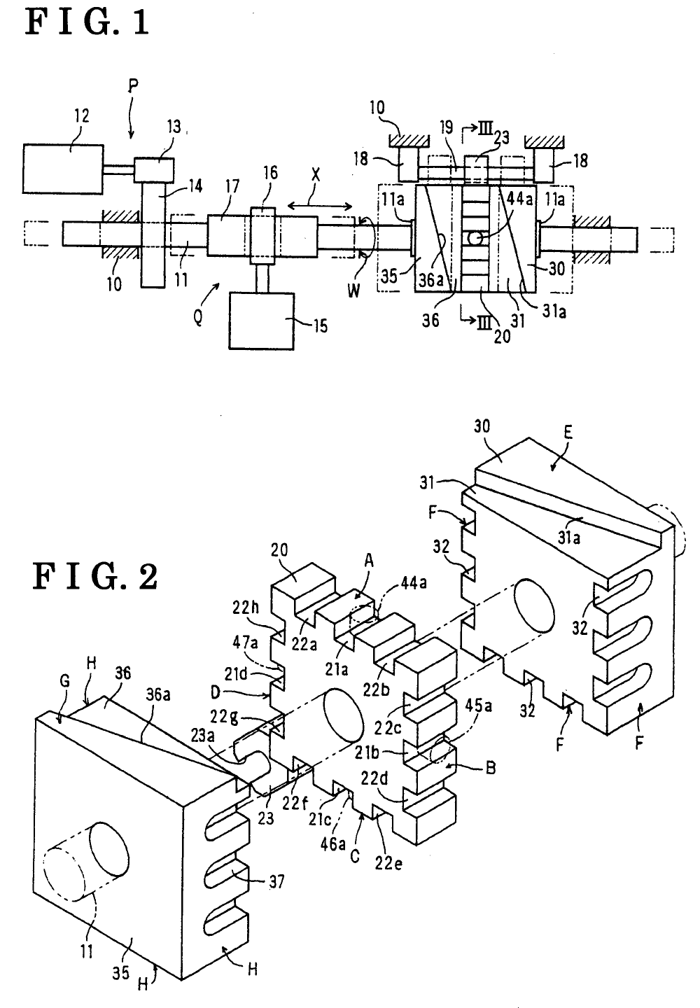

A first embodiment of a shifting apparatus for a transmission according to the present invention will be described hereinafter with reference to attached FIGS. 1 through 6. As illustrated in FIG. 5, the transmission of a vehicle, which is applied to the first embodiment of the present invention, includes an input shaft 2 (a rotational shaft), a main shaft 3 (a rotational shaft), and eight sets of speed change gears. The input shaft 2 is connected to an engine (not illustrated) via a frictional clutch 1. The main shaft 3 is arranged in parallel with the input shaft 2 and connected to driving wheels (not illustrated). The eight sets of speed change gears are provided between the input shaft 2 and the main shaft 3, and are configured by seven forward shift stages and a reverse shift stage, each of which includes a driving gear and a driven gear. A first shifting clutch 4a is mounted on the input shaft 2 and is provided between a reverse driving gear and a first speed driving gear. A second shifting clutch 4b is mounted on the input shaft 2 and provided between a second speed driving gear and a third speed driving gear. A third shifting clutch 4c is mounted on the main shaft 3 and is provided between a fourth speed driven gear and a fifth speed driven gear. A fourth shifting clutch 4d is mounted on the main shaft 3 and is provided between a sixth speed driven gear and a seventh speed driven gear. The shifting clutches 4a to 4d include sleeves respectively, and the sleeves are reciprocated by shift forks 40a, 41a, 42a and 43a, respectively, in an axial direction of the input shaft 2. The driving gears and the driven gears, for the seven forward shift stages and of the reverse shift stage, are selectively connected to the input shaft 2 and the main shaft 3 by a reciprocating movement of the corresponding sleeve, and accordingly, speed changing is performed.

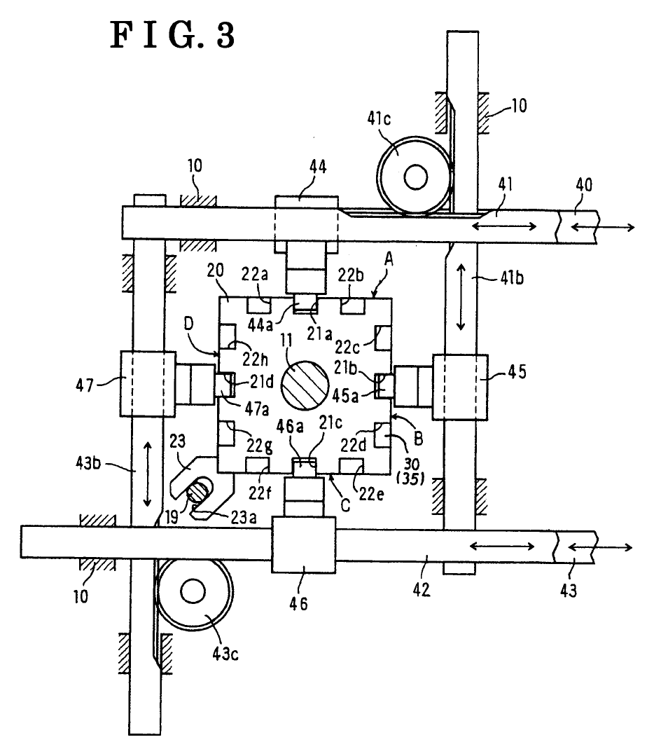

As best shown in FIG. 1, the shifting apparatus for the transmission according to the first embodiment of the present invention mainly includes a shift-and-select shaft 11, a retaining member 20, a first shifting member 30, a second shifting member 35, and first to fourth fork shafts 40, 41, 42 and 43 (see FIG. 3). The shift-and-select shaft 11 is supported by a transmission housing 10 (supporting member). Further, the shift-and-select shaft 11 is rotated by an actuation of a selecting actuator P and is reciprocated in an axial direction by an actuation of a shifting actuator Q. The retaining member 20 is supported by the shift-and-select shaft 11. The first and second shifting members 30 and 35 are also supported by the shift-and-select shaft 11 and are arranged at both axial sides of the returning member 20, respectively. The first to fourth fork shafts 40 to 43 are arranged for transmitting operations of the first and second shifting members 30 and 35 to the shift forks 40a to 43a (see FIG. 3). The shift-and-select shaft 11 is arranged in perpendicular with the input shaft 2 and the main shaft 3, of the transmission, when the shifting apparatus is mounted on the transmission.

As illustrated in FIG. 1, the selecting actuator P is configured with a gear 14, a pinion 13, and a selecting motor 12. The gear 14 is splined with the shift-and-select shaft 11 so as to be slidable in the axial direction of the shift and select shaft 11 but so as to be restricted from a relative rotation with the shift-and-select shaft 11. The pinion 13 is engaged with the gear 14 and is rotatably driven by the selecting motor 12. The shifting actuator Q is configured with a rack 17, a pinion 16, and a shifting motor 15. The rack 17 is circumferentially formed with rack teeth at an outer periphery thereof and is coaxially fixed to the shift-and-select shaft 11. The pinion 16 is engaged with the rack 17 and is rotatably driven by the shifting motor 15.

As illustrated in FIGS. 1 to 4 and as best shown in FIG. 2, each of the retaining member 20, the first shifting member 30 and the second shifting member 35 is formed by a thick board (a board member) member including identical square shape in cross section. Board thickness of each first and second shifting member 30 and 35 is greater than that of the retaining member 20. A round central bore is formed at a center of the retaining member 20 so as to be coaxial with the retaining member 20. Meanwhile, a splined-central bore is formed at each first and second shifting member 30 and 35, so as to be coaxial with each first and second shifting member 30 and 35. The shift-and-select shaft 11, which is arranged horizontally with the transmission, is inserted into the round central bore of the retaining member 20 and splined into the splined-centrals bore of the first and second shifting members 30 and 35. Accordingly, the retaining member 20 is rotatably supported by the shift-and-select shaft 11 at an intermediate portion thereof, and the first and second shifting members 30 and 35 are unrotatably supported by the shift-and-select shaft 11 at both axial sides of the retaining member 20, respectively. Then, the first shifting member 30, the retaining member 20, and the second shifting member 35 are assembled to the shift-and-select shaft 11 by means of a pair of snap rings 11a, which the shift-and-select shaft 11 is further inserted into, in a manner where the first and second shifting member 30 and 35 are in contact with the axial sides of the retaining member 20, respectively, and the retaining member 20 and the first and second shifting members 30 and 35 are stacked. Here, the first shifting member 30 includes an outer surface E and three outer surfaces F, all of which is arranged in parallel with the axial line of the shift-and-select shaft 11. In the same manner, the second shifting member 35 includes an outer surface G and three outer surfaces H, all of which is arranged in parallel with the axial line of the shift-and-select shaft 11. On the above described condition, the first shifting member 30 and the second shifting member 35 are fixedly splined by the shift-and-select shaft 11 in a manner where the outer plan surface E of the first shifting member 30 is arranged to be coplanar with the outer plan surface G of the second shifting member 35, and the three outer plan surfaces F of the first shifting member 30 are arranged to be coplanar with the three outer plan surfaces H of the second shifting member 35, respectively. The retaining member 20 is restricted from moving in the axial direction of the shift-and-select shaft 11, while the retaining member 20 is allowed to rotate relative to the shift-and-select shaft 11.

The retaining member 20 includes four outer plan surfaces A, B, C and D, which are parallel with the axial line of the shift-and-select shaft 11. The outer plan surfaces A, B, C and D are formed with neutral interlock grooves 21a, 21b, 21c and 21d, respectively. Each neutral interlock groove 21a, 21b, 21c and 21d is formed at an intermediate portion of the corresponding outer plan surface A, B, C and D in a direction perpendicular with the axial direction, and extends over an entire length in a board thickness direction of the retaining member 20 so as to be in parallel with the axial line of the shift-and-select shaft 11. Further, the neutral interlock groove 21a, 21b, 21c and 21d each exhibits a substantially identical cross sectional shape so as to be slidably engaged with a corresponding driving pin 44a, 45a, 46a and 47a substantially with no gap therebetween, respectively. The driving pins 44a to 47a will be described later. In addition, shifting interlock grooves 22a and 22b are formed at the outer plan surface A of the retaining member 20. The shifting interlock grooves 22a and 22b are formed adjacent to the neutral interlock groove 21a, i.e., are located at both longitudinal sides of the neutral interlock groove 21a in the direction perpendicular to the axial line of the shift-and-select shaft 11, respectively. A distance between the shifting interlock grooves 22a and 22b is substantially the same as a shifting stroke of the sleeve of the shifting clutch 4a. Further, each shifting interlock groove 22a and 22b extends over the entire length in the board thickness direction of the retaining member 20 so as to be in parallel with the axial line of the shift-and-select shaft 11. In the same manner, shifting interlock grooves 22c and 22d are formed at the outer plan surface B of the retaining member 20. The shifting interlock grooves 22c and 22d are formed adjacent to the neutral interlock groove 21b, i.e., are located at both longitudinal sides of the neutral interlock groove 21b in the direction perpendicular to the axial line of the shift-and-select shaft 11, respectively. A distance between the shifting interlock grooves 22c and 22d is substantially the same as a shifting stroke of the sleeve of the shifting clutch 4b. Further, each shifting interlock groove 22c and 22d extends over the entire length in the board thickness direction of the retaining member 20 so as to be in parallel with the axial line of the shift-and-select shaft 11. Further, shifting interlock grooves 22e and 22f are formed at the outer plan surface C of the retaining member 20. The shifting interlock grooves 22e and 22f are formed adjacent to the neutral interlock groove 21c, i.e., are located at both longitudinal sides of the neutral interlock groove 21c in the direction perpendicular to the axial line of the shift-and-select shaft 11, respectively. A distance between the shifting interlock grooves 22e and 22f is substantially the same as a shifting stroke of the sleeve of the shifting clutch 4c. Further, each shifting interlock groove 22e and 22f extends over the entire length in the board thickness direction of the retaining member 20 so as to be in parallel with the axial line of the shift-and-select shaft 11. Still further, shifting interlock grooves 22g and 22h are formed at the outer plan surface D of the retaining member 20. The shifting interlock grooves 22g and 22h are formed adjacent to the neutral interlock groove 21d, i.e., are located at both longitudinal sides of the neutral interlock groove 21d in the direction perpendicular to the axial line of the shift-and-select shaft 11, respectively. A distance between the shifting interlock grooves 22g and 22h is substantially the same as a shifting stroke of the sleeve of the shifting clutch 4d. Further, each shifting interlock groove 22g and 22h extends over the entire length in the board thickness direction of the retaining member 20 so as to be in parallel with the axial line of the shift-and-select shaft 11. Cross-sectional shape of each shifting interlock groove 22a to 22h is identical to the cross-sectional shape of the neutral interlock grooves 21a to 21d. Further, the retaining member 20 is provided with a protruding-detent portion 23, which protrudes in a radial and outward direction from a corner portion formed by the outer plan surfaces C and D of the retaining member 20. The protruding-detent portion 23 includes a U-shaped groove 23a, which is orientated the radial and outward direction of the shift-and select shaft 11. The U-shaped groove 23a is engaged with a guide rod 19, which extends in parallel with the shift-and-select shaft 11 and of which both ends are securely supported by a pair of guide brackets 18, respectively, the guide brackets 18 which protrude from the transmission housing 10. Accordingly, the retaining member 20 is restricted from relative rotation with the transmission housing 10, regardless of the rotation of the shift-and-select shaft 11.

In the same manner as the retaining member 20, the first shifting member 30 includes the outer plan surface E and the three outer plan surfaces F, which are arranged to be parallel with the axial line of the shift-and-select shaft 11. The outer plan surface E of the shifting member 30 is formed with a stepped recessed-portion 31. The stepped recessed-portion 31 includes a shifting inclined surface 31a, which faces one of axial end surfaces of a rim portion, of the retaining member 20, formed with the neutral interlock grooves 21a to 21d and the shifting interlock grooves 22a to 22d. The shifting inclined surface 31a inclines in the radial direction relative to the axial end surface of the retaining member 20. On the other hand, each of the three outer plan surfaces F of the first shifting member 30 is formed with three non-shifting grooves 32, which extend in parallel with the axial line of the shift-and-select shaft 11. In a case where each of the outer plan surfaces E and F of the first shifting member 30 is arranged to be coplanar with each of the outer plan surfaces A to D of the retaining member 20, the non-shifting grooves 32 are arranged to be continuous with the neutral interlock grooves 21a to 21d and with the shifting interlock grooves 22a to 22h of the corresponding outer plan surface A to D of the retaining member 20. The second shifting member 35 possesses the same general configuration of the first shifting member 30, including the outer plan surface G which includes a stepped recessed-portion 36 with a shifting inclined surface 36a, and the three outer plan surfaces H which respectively include non-shifting grooves 37. The first and second shifting members 30 and 35 are assembled to the shift-and-select shaft 11 in a manner where the first and second shifting members 30 and 35 make a contact with both axial end surfaces of the retaining member 20 so that the shifting inclined surface 31a of the stepped recessed-portion 31 and the shifting inclined portion 36a of the stepped recessed-portion 36 face the retaining member 21, respectively, and where the outer plan surface E, of the first shifting member 30, formed with the stepped recessed-portion 31 and the outer plan surface G, of the second shifting member 35, formed with the stepped recessed-portion 36, are arranged to be coplanar.

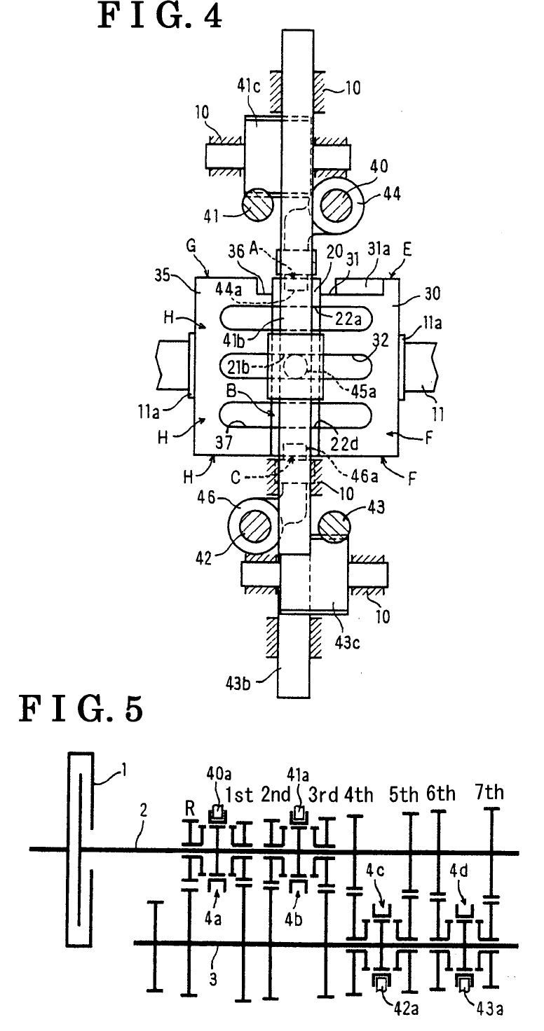

Next, mainly with reference to the FIGS. 3 and 4, the first to fourth fork shafts 40 to 43, which transmit the operations of the first and second shifting members 30 and 35 to the shift forks 40a to 43b, will be described hereinafter. As illustrated in FIGS. 3 and 4, the first and second fork shafts 40 and 41, which are arranged to be in parallel with each other, are supported by the transmission housing 10 at an upper side of the retaining member 20 and of the first and second shifting members 30 and 35, so as to be slidable in a lateral direction as indicated with lateral arrows in FIG. 3, i.e., in a direction being perpendicular to the axial line of the shift-and-select shaft 11. Meanwhile, the third and fourth fork shafts 42 and 43 are supported by the transmission housing 10 at a lower side of the retaining member 20 and of the first and second shifting members 30 and 35, so as to be slidable in parallel with the first and second fork shafts 40 and 41. With reference to FIG. 3, the shift forks 40a to 43a, which are engaged with sleeves of the shifting clutches 4a to 4d shown in FIG. 5 respectively, are fixed to the right end portions of the fork shafts 40 to 43 in FIG. 3, respectively, the right end portions which are not illustrated in the drawing. As illustrated in FIG. 3, a shift head 44 is fixed to the first fork shaft 40 at an upper direction of the shift-and-select shaft 11. The driving pin 44a is formed at the shift head 44 and extends towards the shift-and-select shaft 11. Further, the driving pin 44a is engaged with the neutral interlock groove 21a which is formed at an outer plan surface A positioned at top portion of the retaining member 20 in FIG. 3. On the other hand, a shift head 46 is fixed to the third fork shaft 42 at an lower direction of the shift-and-select shaft 11, and the driving pin 46a is formed at the shift head 46 and extends towards the shift-and-select shaft 11. Further, the driving pin 46a is engaged with the neutral interlock groove 21c which is formed at an outer plan surface C positioned at a bottom portion of the retaining member 20 in FIG. 3.

Further, an auxiliary shaft 41b is provided at a right side of the retaining member 20 and of the first and second shifting member 30 and 35 in FIG. 3, and is supported by the transmission housing 10 so as to be slidable in a vertical direction, as indicated with vertical arrows in FIG. 3, which is perpendicular to the axial line of the shift-and-select shaft 11. On the other hand, an auxiliary shaft 43b is provided at a left side of the retaining member 20 and of the first and second shifting member 30 and 35 in FIG. 3, and is supported by the transmission housing 10 so as to be slidable in a vertical direction in the same manner as the auxiliary shaft 41b. The fork shafts 41, 43 and the auxiliary shafts 41b, 43b are formed with a rack, respectively. A gear 41c, which is supported by the transmission housing 10, is engaged with the rack of the auxiliary shaft 41b and of the second fork shaft 41. Accordingly, the auxiliary shaft 41b and the second auxiliary shaft 41 are moved slidably in association with each other. In the same manner, a gear 43c, which is supported by the transmission housing 10, is engaged with the rack of the auxiliary shaft 43b and of the fourth fork shaft 43. Accordingly, the auxiliary shaft 43b and the fourth fork shaft 43 are moved slidably in association with each other. As illustrated in FIG. 3, a shift head 45 is fixed to the auxiliary shaft 41b at a laterally right direction of the shift-and-select shaft 11. The driving pin 45a is formed at the shift head 45 and is engaged with the neutral interlock groove 21b which is formed at an outer plan surface B positioned at a right portion of the retaining member 20 in FIG. 3. On the other hand, a shift head 47 is fixed to the auxiliary shaft 43b at a laterally left direction of the shift-and-select shaft 11. The driving pin 47a is formed at the shift head 47 and is engaged with the neutral interlock groove 21d which is formed at an outer plan surface D positioned at a left portion of the retaining member 20 in FIG. 3. As described above, when each driving pin 44a to 47a is located in any of neutral interlock groove 21a to 21d, the transmission for the vehicle is in a neutral condition.

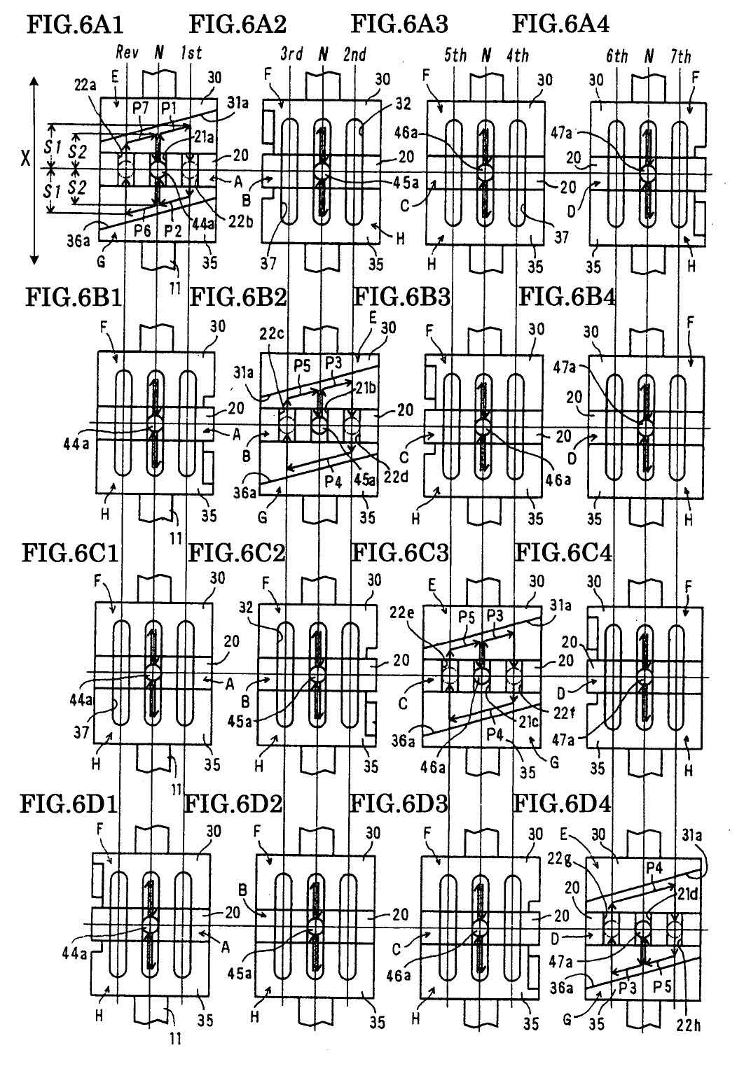

Next, operations of the shifting apparatus for the transmission according to the first embodiment will be described hereinafter. Back to FIG. 1, a controlling apparatus (not illustrated) for the shifting apparatus operates the selecting motor 12 in accordance with an operating condition of the vehicle detected by a sensor (not illustrated), an operating condition which is represented by throttle opening angle, vehicle speed, or the like. When the selecting motor 12 is operated by the controlling apparatus, the shift-and-select shaft 11 is rotated in a direction of an arrow W illustrated in FIG. 1, via the pinion 13 and the gear 14. Then, the controlling apparatus sequentially detects the outer plan surfaces E and G, of the first and second shifting members 30 and 35 fixed to the shift-and-select shaft 11, in a position where the first outer plan surfaces E and G of the first and second shifting members 30 and 35 are arranged to be continuous with either of the outer plan surfaces A to D, of the retaining member 20, and then, the controlling apparatus operates the shifting motor 15 at a detected condition. When the shifting motor 15 is operated by the controlling apparatus, the shift-and-select shaft 11 is reciprocated in a direction of an arrow X illustrated in FIG. 1, i.e., in the axial direction of the shift-and-select shaft 11, via the pinion 16 and the rack 17. Then, the first to fourth shifting clutches 4a to 4d are operated via the driving pins 44a to 47a and the fork shafts 40 to 43. Regarding the above-described operations, the frictional clutch 1 of the transmission is operated and speed changing is performed. According to the first embodiment, when each driving pin 44a to 47a is located in each corresponding neutral interlock groove 21a to 21d, i.e., when the transmission of the vehicle is in the neutral condition, the shifting apparatus for the transmission is retained at a base position. The shift-and-select shaft 11 is not rotated by the selecting motor 12 unless the shifting apparatus for the transmission is retained at the base position. The operations of the shifting apparatus for the transmission will be described in detail hereinafter with reference to FIG. 6. The direction of the arrow X in the FIG. 1 corresponds to a vertical direction in FIGS. 6, 9 and 10.

FIGS. 6A1 to 6A4 are drawings of the retaining member 20 and the first and second shifting members 30 and 35, illustrated as seen from the surfaces A, B, C and D of the retaining member 20, in a condition where the outer plan surface E, of the first shifting member 30, formed with the stepped recessed-portion 31 and the first outer plan surface G, of the second shifting member 35, formed with the stepped recessed-portion 36, are detected in a position to be continuous with the outer plan surface A of the retaining member 20.

When the vehicle is started at a first speed from a stopped condition, the controlling apparatus detects the outer plan surfaces E and G, of the first and second shifting members 30 and 35, in a position where the first outer plan surfaces E and G, of the first and second shifting members 30 and 35, are arranged to be coplanar with the outer plan surface A of the retaining member 20 in conditions where the engine of the vehicle is started, the frictional clutch 1 of the transmission is disengaged, and where the shifting apparatus for the transmission is retained at the base position. Immediately after the above-described position is detected, the transmission of the vehicle is retained at the neutral condition where no shift stage is established, and as illustrated in FIG. 6A1, the driving pin 44a of the shift head 44 is retained in the neutral interlock groove 21a. When the shifting motor 15 is operated by the controlling apparatus and the retaining member 20 and the first and second shifting members 30 and 35 are downwardly moved in the axial direction of the shift-and-select shaft 11 (i.e., downwardly in the direction of the arrow X in FIG. 6) with a predetermined distance S1 illustrated in FIG. 6A1 via the shift-and-select shaft 11, the driving pin 44a is moved relative to the retaining member 20 and the first and second shifting members 30 and 35 in directions as indicated with a series of three arrows p1. In other words, the driving pin 44a exits from the neutral interlock groove 21a of the retaining member 20 and enters into the stepped recessed-portion 31 of the first shifting member 30, by the downward movements of the retaining member 20 and the first and second shifting members 30 and 35. Then, the driving pin 44a makes a contact with the shifting inclined surface 31a of the first shifting member 30, and is moved in a direction being perpendicular to the shift-and-select shaft 11 (i.e., in a right direction in FIG. 6) to a position where the driving pin 44a faces the shifting interlock groove 22b, by a component force generated by a contact of the driving pin 44a with the shifting inclined surface 31a. Accordingly, the first shift fork 40a is moved via the first fork shaft 40, and with reference to FIG. 5, the sleeve of the first shifting clutch 4a is operated in axially right direction of the input shaft 2, of the transmission of the vehicle. Finally, the first driving gear is connected to the input shaft 2 of the transmission and a first shift stage is established. Then, back to FIG. 6A1, the driving pin 44a enters into the shifting interlock groove 22b by upwardly returning movements of the retaining member 20 and the first and second shifting members 30 and 35, and is retained in the shifting interlock groove 22b. In the above-described condition, the frictional clutch 1 of the transmission is engaged by the controlling apparatus, and accordingly, the vehicle is started driving at the first speed. Additionally, when the retaining member 20 and the first and second shifting members 30 and 35 are reciprocated, each of the other driving pins 45a to 47a, which is retained in the corresponding neutral interlock groove 21b to 21d formed at the corresponding outer plan surface B to D, once enters into one of the non-shifting grooves 32, which faces each neutral interlock groove 21b to 21d, of each outer plan surface F by the downward movements of the retaining member 20 and the first and second shifting members 30 and 35. Then, each driving pin 45a, 46a and 47a returns into and is retained in the corresponding neutral interlock groove 21b, 21c and 21d by the upwardly returning movements of the retaining member 20 and the first and second shifting members 30 and 35.

The driving speed is shifted from the first speed to the second speed by releasing the frictional clutch 1 of the transmission once and then engaging the frictional clutch 1 again, after resetting the first shift stage and establishing the second shift stage, in the same manner as an operation of general manual transmission. More specifically, the controlling apparatus releases the frictional clutch 1 of the transmission at first, and then operates the shifting motor 15. Then, the retaining member 20 and the first and second shifting members 30 and 35 are upwardly moved in the axial direction of the shift-and-select shaft 11 (i.e., upwardly in the direction of the arrow X in FIG. 6) with a predetermined distance S2 illustrated in FIG. 6A1 by the shifting motor 15 via the shift-and-select shaft 11. Accordingly, the driving pin 44a is moved relative to the retaining member 20 and the first and second shifting members 30 and 35 in directions as indicated with a series of three arrows p2 shown in FIG. 6A1. In other words, in the same manner as described above, the driving pin 44a is moved, in the direction perpendicular to the shift-and-select shaft 11 (i.e., in a left direction in FIG. 6) to a position where the driving pin 44a faces the neutral interlock groove 21a. Then, the first shift fork 40a is moved to return to a neutral position via the first fork shaft 40. Accordingly, the first shift stage is reset and the shifting apparatus for the transmission returns to the base position. Additionally, each of the other driving pins 45a to 47a once enters into one of the non-shifting grooves 37, which faces each neutral interlock groove 21b to 21d, of each outer plan surface H formed at the second shifting member 35 by upward movements of the retaining member 20 and the first and second shifting members 30 and 35, and then returns into the corresponding neutral interlock groove 21b to 21d by downwardly returning movements of the retaining member 20 and the first and second shifting members 30 and 35.

In the above-described condition, the controlling apparatus operates the selecting motor 12 and rotates the first and second shifting members 30 and 35 via the shift-and-select shaft 11 by means of the selecting motor 12. Then, as illustrated in FIGS. 6B1 to 6B4, the controlling apparatus detects the first outer plan surfaces E and G, of the first and second shifting members 30 and 35, in a position where the first outer plan surfaces E and G are arranged to be coplanar with the outer plan surface B of the retaining member 20. Then, in the same manner as aforementioned, the first and second shifting members 30 and 35 are downwardly moved in the axial direction of the shift-and-select shaft 11 with the predetermined distance S1 by the actuation of the shifting motor 15. Accordingly, the driving pin 45a, which is retained in the neutral interlock groove 21b, is moved relative to the retaining member 20 and the first and second shifting members 30 and 35 in directions as indicated with a series of three arrows p3 illustrated in FIG. 6B2, and in the same manner as the aforementioned operation of the first shift stage, the driving pin 45a is moved in the direction being perpendicular with the shift-and-select shaft 11 (i.e., in the right direction in FIG. 6) to a position where the driving pin 45a faces the shifting interlock groove 22d of the retaining member 20. Accordingly, the second shift fork 41a is moved in left direction in FIG. 5, via the auxiliary shaft 41b and the second fork shaft 41 and the sleeve of the second shifting clutch 4b is operated in the left direction. Finally, the second speed driving gear is connected to the input shaft 2 of the transmission and a second shift stage is established. Then, the driving pin 45a enters into the shifting interlock groove 22d by the upwardly returning movements of the retaining member 20 and the first and second shifting members 30 and 35, and is retained in the shifting interlock groove 22d of the retaining member 20. In the above-described condition, the frictional clutch 1 of the transmission is engaged by the operation of the controlling apparatus, and accordingly, the driving speed is shifted and the vehicle starts driving at the second speed. The other driving pins 44a, 46a and 47a are operated in the same manner as described above so that the description about the operations of the driving pins 44a, 46a and 47a will be omitted herein.

Driving speed at third speed to seventh speed is shifted in the same manner as described above. When the driving speed is shifted from the second speed to the third speed, the frictional clutch 1 of the transmission is once released and the retaining member 20 and the first and second shifting members 30 and 35 are upwardly moved in the axial direction of the shift-and-select shaft 11 with the predetermined distance S1. Then, the driving pin 45a is moved relative to the retaining member 20 and the first and second shifting member 30 and 35 in directions as indicated with a series of three arrows p4 illustrated in FIG. 6B2. More specifically, further in the same manner as described above, the driving pin 45a is moved in the direction being perpendicular with the shift-and-select shaft 11 (i.e., in the left direction in FIG. 6) to a position where the driving pin 45a faces the shifting interlock groove 22c formed at the outer plan surface B of the retaining member 20. Accordingly, the second fork shaft 41 is moved in a right direction in FIG. 5, via the auxiliary shaft 41b and the second fork shaft 41, and the sleeve of the second shifting clutch 4b is operated in the right direction. Then, the second speed driving gear is released from the input shaft 2 of the transmission, and the third speed driving gear is connected to the input shaft 2. Afterward, a third shift stage is established. Then, back to FIG. 6B2, the driving pin 45a enters into and retained in the shifting interlock groove 22d, and the frictional clutch 1 of the transmission is engaged again. Therefore, the driving speed of the vehicle is shifted to the third speed.

In the same manner, when the driving speed is shifted from the third speed to the fourth speed, the frictional clutch 1 of the transmission is released at first, and then the retaining member 20 and the first and second shifting members 30 and 35 are downwardly moved in the axial direction of the shift-and-select shaft 11 with the predetermined distance S2. Accordingly, as illustrated in FIG. 6B2, the driving pin 45a is moved in directions as indicated with a series of three arrows p5, i.e., the driving pin 45a enters the stepped-recessed portion 31 of the first shifting member 30, and is moved to a position where the driving pin 45a faces the neutral interlock groove 21b of the retaining member 20. Then, the second shift fork 41a is returned to the neutral position via the auxiliary shaft 41b and the second fork shaft 41. Accordingly, the third shift stage is reset and the shifting apparatus for the transmission returns to the base position. In such condition, the first and second shifting members 30 and 35 are rotated by the selecting motor 12 of the selecting actuator P, and the first outer plan surfaces E and G, of the first and second shifting members 30 and 35, are detected in a position where the first outer plan surfaces E and G are arranged to be continuous with the outer plan surface C of the retaining member 20 as illustrated in FIGS. 6C1 to 6C4. Then, the retaining member 20 and the first and second shifting members 30 and 35 are downwardly moved in the axial direction of the shift-and-select shaft 11 with the predetermined distance S1 and the driving pin 46a is moved in directions indicated with the series of three arrows p3 illustrated in FIG. 6C3. Accordingly, a fourth shift stage is established and then, the frictional clutch 1 of the transmission is engaged again. Therefore, the driving speed is shifted to the fourth speed.

The driving speed is shifted from the fourth speed to the fifth speed, from the fifth speed to the sixth speed, and from the sixth speed to the seventh speed, in the same manner as described above. When the driving speed is shifted from the fifth speed to the sixth speed, the frictional clutch 1 of the transmission is released at first, and the driving pin 46a is moved in directions as indicated with the series of three arrows p5 as illustrated in FIG. 6C3. Then, the third shift fork 42a is returned to the neutral position via the third fork shaft 42 and the shifting apparatus for the transmission returns to the base position. Afterward, the first and second shifting members 30 and 35 are rotated by the selecting motor 12 of the selecting actuator P, and the first outer plan surfaces E and G, of the first and second shifting members 30 and 35, are detected in a position where the first outer plan surfaces E and G are arranged to be continuous with the outer plan surface D of the retaining member 20 as illustrated in FIGS. 6D1 to 6D4. Next, the retaining member 20 and the first and second shifting members 30 and 35 are upwardly reciprocated in the axial direction of the shift-and-select shaft 11, and finally, the driving speed is shifted from the fifth speed to the sixth speed. On the other hand, when the driving speed is shifted from the sixth speed to the seventh speed, by the retaining member 20 and the first and second shifting members 30 and 35 are downwardly reciprocated in the axial direction of the shift-and-select shaft 11, and the driving pin 47a is moved relative to the retaining member 20 and the first and second shifting member 30 and 35 in directions as indicated with the series of three arrows p4 illustrated in FIG. 6D4. Therefore, the seventh shift stage is established and the driving speed is shifted from the sixth speed to the seventh speed. So far, step-up operations, for shifting the shift stage of the transmission from neutral condition to the seventh shift stage, are described above. On the other hand, step-down operations, for shifting the shift stage of the transmission from the seventh shift stage to the neutral condition, may be performed in a reverse order of the step-up operations.

In addition, in a case of reverse driving, the controlling apparatus detects the first outer plan surfaces E and G, of the first and second shifting members 30 and 35, in the position where the first outer plan surfaces E and G are arranged to be coplanar with the outer plan surface A of the retaining member 20, and moves the retaining member 20 and the first and second shifting members 30 and 35 upwardly in the axial direction of the shift-and-select shaft 11, in the conditions where the engine of the vehicle is started, the frictional clutch 1 of the transmission is disengaged, and where the transmission of the vehicle is in the neutral condition, i.e., the shifting apparatus for the transmission is retained at the base position. Accordingly, the driving pin 44a is moved relative to the retaining member 20 and the first and second shifting members 30 and 35, in directions indicated with a series of three arrows p6. Then, the first shifting clutch 4a is operated in an inverted direction with the direction for forming the first shift stage, i.e., in the left direction of the input shaft 2 of the transmission illustrated in FIG. 5, via the first fork shaft 40, and a reversing shift stage is established. Afterward, the driving pin 44a enters into the shifting interlock groove 22a formed at the outer plan surface A of the retaining member 20 and is retained therein. In such condition, the controlling apparatus engages the frictional clutch 1 of the transmission, and accordingly, the vehicle is started driving backward. When the frictional clutch 1 is disengaged and the retaining member 20 and the first and second shifting members 30 and 35 are downwardly moved in the axial direction of the shift-and-select shaft 11 with the predetermined distance S2 at this reversing condition, the driving pin 44a is moved in directions as indicated with a series of three arrows p7. Then, the reversing shift stage is reset and the vehicle stops driving backward.

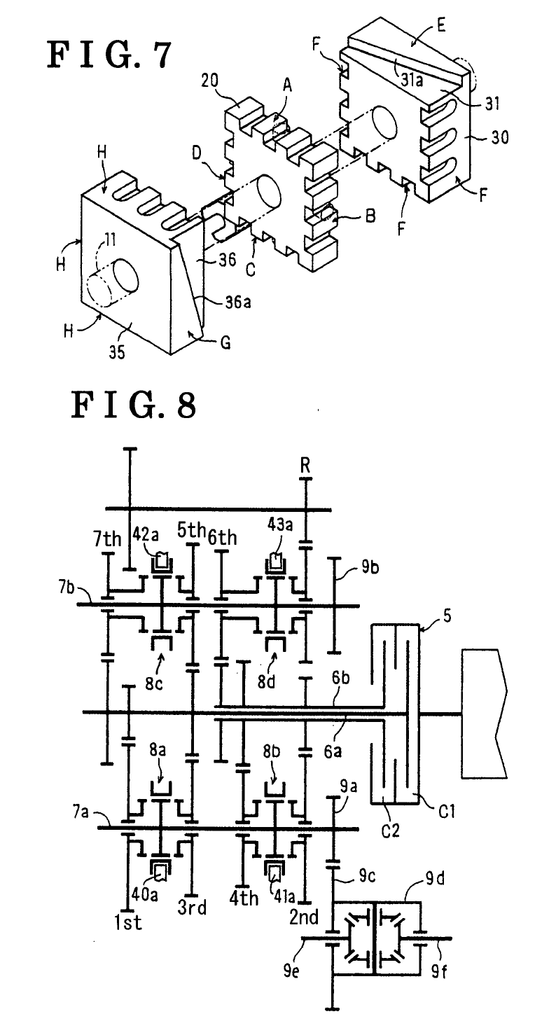

Next, a second embodiment of the shifting apparatus for the transmission according to the present invention will be described hereinafter with reference to FIGS. 7 to 10. The shifting apparatus for the transmission according to the second embodiment is applied to a gear-type automated transmission including a dual-clutch 5, seven forward shift stage and a reverse shift stage. As illustrated in FIG. 8, the automated transmission applied to the second embodiment includes a first input shaft 6a (rotational shaft), a second input shaft 6b (rotational shaft), a first sub shaft 7a (rotational shaft) and a second sub shaft 7b (rotational shaft). The second input shaft 6b is a cylindrical shaft and is coaxially and rotatably provided surrounding the first input shaft 6a. The first and second sub shafts 7a and 7b are arranged in parallel with the first and second input shafts 6a and 6b, respectively. Further, the first and second input shafts 6a and 6b are rotated by the engine of the vehicle via a first frictional clutch C1 and a second frictional clutch C2, of the dual-clutch 5, respectively. A first gear train and a third gear train are provided between the first input shaft 6a and the first sub shaft 7a. A second gear train and a fourth gear train are provided between the second input shaft 6b and the first sub shaft 7a. A fifth gear train and a seventh gear train are provided between the first input shaft 6a and the second sub shaft 7b, and a sixth gear train and a reverse gear train are provided between the second input shaft 6b and the second sub shaft 7b. In addition, a first shifting clutch 8a is mounted on the first sub shaft 7a and is provided between each driven gear of the first and third gear train. A second shifting clutch 8b is mounted on the first sub shaft 7a and is provided between each driven gear of the second and fourth gear train. Further, a third shifting clutch 8c is mounted on the second sub shaft 7b and is provided between each driven gears of the fifth and seventh gear train. Still further, a fourth shifting clutch 8d is mounted on the second sub shaft 7b and is provided between each driven gear of the sixth and the reverse gear train. The first to fourth shifting clutches 8a to 8d are engaged with first to fourth shift forks 40a to 43a, respectively.

The first and second frictional clutches C1 and C2 of the dual-clutch 5 are controlled by a controlling apparatus for the gear-type automated transmission. When both the first and second frictional clutches C1 and C2 are being shifted, both are in half-engaged condition. In such condition, when a transmitting torque of the first frictional clutch C1 is increased, a transmitting torque of the second frictional clutch C2 is reduced. On the other hand, when the transmitting torque of the second frictional clutch C2 is increased, the transmitting torque of the first frictional clutch C1 is reduced. After completing shifting the first and second frictional clutches C1 and C2, either one of the frictional clutches C1 or C2 is completely engaged and the other is completely disengaged. In such condition, the transmitting torque of the completely engaged frictional clutch, from among the first and second frictional clutches C1 and C2, changes to a predetermined maximum value, while the transmitting torque of the other completely disengaged frictional clutch changes to zero. In addition, a sleeve of each shifting clutch 8a to 8d is reciprocated by the corresponding shift fork 40a to 43a in an axial direction of the first and second input shafts 6a and 6b of the transmission. Each driven gear of each gear train is selectively connected to the first sub shaft 7a or to the second sub shaft 7b by the reciprocating movement of the sleeves, and accordingly, speed changing is performed.

In the same manner as the first embodiment, the shifting apparatus for the transmission according to the second embodiment mainly includes the shift-and-select shaft 11 supported by the transmission housing 10 (supporting member), the retaining member 20 and the first and second shifting members 30 and 35, all which are supported by the shift-and-select shaft 11, and first to fourth fork shafts 40 to 43, which transmit operations of the first and second shifting members 30 and 35 to the shift forks 40a to 43a. The shift-and-select shaft 11 is perpendicularly arranged relative to the first and second input shaft 6a and 6b when mounted thereon, and is rotated and axially reciprocated by the selecting actuator P and the shifting actuator Q, both which possesses the identical configurations as the first embodiment of the present invention, respectively.

Each of the retaining member 20 and the first and second shifting members 30 and 35 possesses the identical configuration of the corresponding component used in the first embodiment. In the same manner as the first embodiment, the retaining member 20 is rotatably attached to the shift-and-select shaft 11, while the first and second shifting members 30 and 35 are securely attached to the shift-and-select shaft 11, in a manner where the first and second shifting members 30 and 35 are in contact with the retaining member 20 and are stacked thereto. In the first embodiment, the outer plan surface E formed with the stepped recessed-portion 31, of the first shifting member 30, and the outer plan surface G formed with the stepped recessed-portion 36, of the second shifting member 35, are securely attached to the shift-and-select shaft 11 so as to be coplanar with each other. On the other hand, in the second embodiment, the outer plan surface E of the first shifting member 30 and the outer plan surface G of the second shifting member 35 are arranged being shifted by a right angle relative to each other, i.e., the outer plan surface G of the second shifting member 35 is arranged to be coplanar with one of the outer plan surface F, of the first shifting member 30, which is located next to the outer plan surface E.

In the second embodiment, each of the first to fourth fork shafts 40 to 43 possesses the identical configuration as the first embodiment so that the specific configuration thereof is not described herein. However, all of the first to fourth fork shafts 40 to 43 are arranged in coplanar and in parallel, and are arranged to be perpendicular to the shift-and-select shaft 11. When each driving pin 44a and 45a is moved from the corresponding neutral interlock groove 21a and 21b to the shifting interlock groove 22b and 22d, each first and second shift fork 40a and 41a is moved in a left direction as shown in FIG. 8, via the corresponding fork shaft 40 and 41. On the other hand, when each driving pin 46a and 47a is moved from the corresponding neutral interlock groove 21c and 21d to the shifting interlock groove 22f and 22h, each third and fourth shift fork 42a and 43a is moved in a right direction as shown in FIG. 8, via the corresponding fork shaft 42 and 43.

Next, operations of the shifting apparatus for the transmission according to the second embodiment will be described hereinafter. According to the second embodiment, when the driving pins 44a, 45a, 46a and 47a are located in the neutral interlock grooves 21a, 21b, 21c and 21d, respectively, i.e., when the transmission of the vehicle is in the neutral condition, the shifting apparatus for the transmission is retained at a base position, in the same manner as the first embodiment. However, the shift-and-select shaft 11 is rotated by the actuation of the selecting motor 12 even when each driving pin 44a to 47a is located in either of the shifting interlock grooves 22a to 22h of the retaining member 20, regardless of the base position.

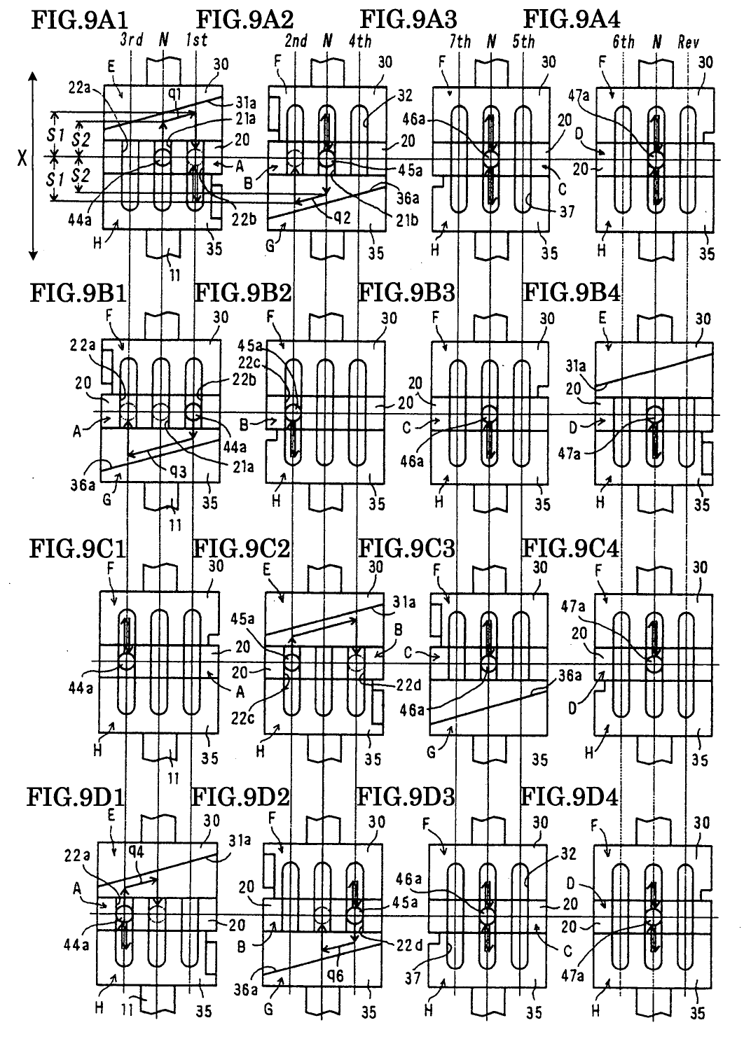

FIG. 9A1 to 9A4 are drawings of the retaining member 20 and the first and second shifting members 30 and 35, illustrated as seen from the outer plan surfaces A, B, C and D of the retaining member 20, in a condition where the outer plan surface E, of the first retaining member 30, formed with the stepped recessed-portion 31 is detected in a position to be coplanar with the outer plan surface A of the retaining member 20, i.e., the outer plan surface G, of the second shifting member 35, formed with the stepped recessed-portion 36 is detected in a position to be coplanar with the outer plan surface B of the retaining member 20.

When the vehicle is started at the first speed from the stopped condition, the controlling apparatus detects the outer plan surfaces E and G, of the first and second shifting members 30 and 35, in a position where the outer plan surface E is coplanar with the outer plan surface A of the retaining member 20, while the outer plan surface G is coplanar with the outer plan surface B of the retaining member 20, as illustrated in FIGS. 9A1 to 9A4, in conditions where the engine of the vehicle is started, the first and second frictional clutches C1 and C2 of the dual-clutch 5 is disengaged, and further when the shifting apparatus for the transmission is retained at the base position. Immediately after detecting the above-described position, the transmission of the vehicle is in the neutral condition where no shift stage is established, and as illustrated in FIG. 9A1, the driving pin 44a of the shift head 44 is retained in the neutral interlock groove 21a of the retaining member 20. In the above-described condition, when the shifting motor 15 is operated by the controlling apparatus and the retaining member 20 and the first and second shifting members 30 and 35 are downwardly moved in the axial direction of the shift-and-select shaft 11 (i.e., downwardly in the direction of arrow X in FIG. 9) with the predetermined distance S1 illustrated in FIG. 9A1 via the shift-and-select shaft 11, the driving pin 44a is moved in directions as indicated with a series of three arrows q1 in the same manner as the first embodiment. Then, the first shift fork 40a is moved via the first fork shaft 40, and with reference to FIG. 8, the sleeve of the first shifting clutch 8a is operated in axially left direction of the first and second input shafts 6a and 6b of the transmission of the vehicle. Accordingly, the first driven gear is connected to the first sub shaft 7a and the first shift stage is established. Then, the driving pin 44a enters into the shifting interlock groove 22b of the retaining member 20 because of the upwardly returning movements of the retaining member 20 and the first and second shifting members 30 and 35, and is retained at the shifting interlock groove 22b. Additionally, when the retaining member 20 and the first and second shifting members 30 and 35 are reciprocated as described above, the driving pin 45a, which is retained in the neutral interlock groove 21b formed at the outer plan surface B of the retaining member 20, enters into the non-shifting groove 32, which faces the neutral interlock groove 21b, of the outer plan surface F of the first shifting member 30 by the downward movements of the retaining member 20 and the first and second shifting members 30 and 35, and then returns into and is retained in the neutral interlock groove 21b again by the upwardly returning movements of the retaining member 20 and the first and second shifting members 30 and 35. In such condition, the first frictional clutch C1 of the dual-clutch 5 is engaged by the operation of the controlling apparatus, and accordingly, the vehicle is started driving at the first speed.

During the vehicle being driven at the first speed, the controlling apparatus upwardly moves the retaining member 20 and the first and second shifting members 30 and 35 by the predetermined distance S1, and accordingly, the driving pin 45a retained in the neutral interlock groove 21b formed at the outer plan surface B of the retaining member 20 is moved in directions as indicated with a series of three arrows q2 as illustrated in FIG. 9A2. More specifically, the driving pin 45a enters into the stepped recessed-portion 36 of the second shifting member 35, and then the driving pin 45a is moved in the perpendicular direction relative to the shift-and-select shaft 11 (i.e., in the left direction in FIG. 9) to a position where the driving pin 45a faces the shifting interlock groove 22c formed at the outer plan surface B of the retaining member 20. Here, the second shift fork 41a is moved via the second fork shaft 41 because of the upwardly movements of the retaining member 20 and the first and second shifting members 30 and 35. Accordingly, the second speed driven gear is connected to the first sub shaft 7a and the second shift stage is established. Further, the driving pin 45a enters into the shifting interlock groove 22c and is retained therein because of the downwardly returning movements of the retaining member 20 and the first and second shifting members 30 and 35. In such condition, the second frictional clutch C2 of the dual-clutch 5 is disengaged so that force transmission by the second shift stage is not performed. However, when the vehicle condition changes to a predetermined driving condition, the first frictional clutch C1 is released and the second frictional clutch C2 is engaged by the operation of the controlling apparatus. Then, the first speed driving is changed to the second speed driving.

During the vehicle is driven at the second speed, the controlling apparatus rotates the first and second shifting members 30 and 35 by means of the selecting motor 12 of the selecting actuator P and then, detects the outer plan surface E, of the first shifting member 30, which is formed with the stepped recessed-portion 31, and the outer plan surface G, of the second shifting member 35, which is formed with the stepped recessed-portion 36, in a position where the outer plan surface E is arranged to be coplanar with the outer plan surface D of the retaining member 20 and the outer plan surface G is arranged to be coplanar with the outer plan surface A of the retaining member 20 as illustrated in FIGS. 9B1 to 9B4. In such condition, when the retaining member 20 and the first and second shifting members 30 and 35 are upwardly moved with the predetermined distance S1, the driving pin 44a, which is retained at the shifting interlock groove 22b formed at the outer plan surface A of the retaining member 20, is moved in directions as indicated with a series of three arrows q3 as illustrated in FIG. 9B 1. Then, in the same manner as described above, the first speed driven gear is separated from the first sub shaft 7a and the first gear stage is reset. Further, the third speed driven gear is connected to the first sub shaft 7a and the third shift stage is established. Still further, the driving pin 44a enters into the shifting interlock groove 22a formed at the outer plan surface A of the retaining member 20 and is retained therein because of the downwardly returning movements of the retaining member 20 and the first and second shifting members 30 and 35. In such condition, the first frictional clutch C1 of the dual-clutch 5 is disengaged so that the force transmission by the third shift stage is not performed. However, when the vehicle condition changes to the predetermined driving condition, the second frictional clutch C2 is released and the first frictional clutch C1 is engaged by the operation of the controlling apparatus and then, the second speed driving is changed to the third speed driving.

During the vehicle is driven at the third speed, the second speed driven gear is separated from the first sub shaft 7a and the second shift stage is reset. Then, the fourth speed driven gear is connected to the first sub shaft 7a and the fourth shift stage is established. Further, when the vehicle condition changes to the predetermined driving condition, the second frictional clutch C2 of the dual-clutch 5 is engaged, and the third speed driving is changed to the fourth speed driving.

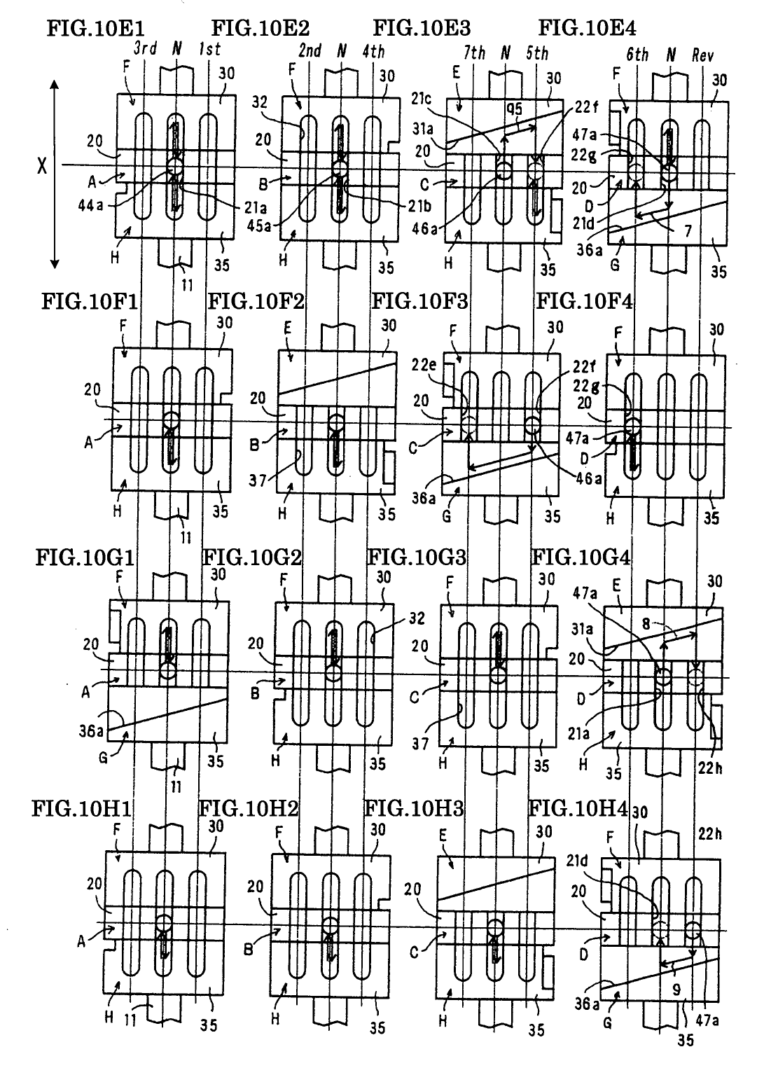

During the vehicle driving at the fourth speed, the controlling apparatus detects the outer plan surface E of the first shifting member 30 and the outer plan surface G of the second shifting member 35 in a position as illustrated in FIGS. 9D1 to 9D4, i.e., in a position where the outer plan surface E is arranged to be coplanar with the outer plan surface A of the retaining member 20 and the outer plan surface G is arranged to be coplanar with the outer plan surface B of the retaining member 20. Then, the retaining member 20 and the first and second shifting members 30 and 35 are downwardly moved with the predetermined distance S2 as illustrated in FIG. 9A1. Further, the driving pin 44a, which is retained in the shifting interlock groove 22a formed at the outer plan surface A of the retaining member 20, is moved in directions as indicated with a series of three arrows q4 as illustrated in FIG. 9 D1 and is returned to the neutral interlock groove 21a of the retaining member 20. Accordingly, the third shift stage is reset. Afterward, as illustrated in FIGS. 10E1 to 10E4, the controlling apparatus detects the outer plan surface E, of the first shifting member 30, which is formed with the stepped recessed-portion 31, and the outer plan surface G, of the second shifting member 35, which is formed with the stepped recessed-portion 36, in a position where the outer plan surface E is arranged to be coplanar with the outer plan surface C of the retaining member 20 and the outer plan surface G is arranged to be coplanar with the outer plan surface D of the retaining member 20. Then, in the same manner as described above, when the retaining member 20 and the first and the second shifting members 30 and 35 are downwardly moved with the predetermined distance S1, the driving pin 46a, which is retained in the neutral interlock groove 21c formed at the outer plan surface C of the retaining member 20, is moved relative to the retaining member 20 and the first and second shifting members 30 and 35 in directions as indicated with a series of three arrows q5 as illustrated in FIG. 10E3. Then, in the same manner as described above, the fifth speed driven gear is connected to the second sub shaft 7b and the fifth shift stage is established. Further, the driving pin 46a enters into and retained in the shifting interlock groove 22f formed at the outer plan surface C of the retaining member 20. In such condition, when the vehicle condition changes to the predetermined driving condition, the first frictional clutch C1 of the dual-clutch 5 is engaged by the operation of the controlling apparatus, and the fourth speed driving is changed to fifth speed driving.

During the vehicle is driven at the fifth speed, the controlling apparatus detects the outer plan surface E of the first shifting member 30 and the outer plan surface G of the second shifting member 35 in the position as illustrated in FIGS. 9D1 to 9D4. Then, the retaining member 20 and the first and second shifting members 30 and 35 are upwardly moved with the predetermined distance S2. Further, the driving pin 45a, which is retained in the shifting interlock groove 22d formed at the outer plan surface B of the retaining member 20, is moved in directions as indicated with a series of three arrows q6 as illustrated in FIG. 9D2 and is returned to the neutral interlock groove 21b of the retaining member 20. Accordingly, the fourth shift stage is reset and in the same manner as above (refer to a series of three arrows q7 illustrated in FIG. 10E4), the sixth shift stage is established. In addition, when the vehicle condition changes to the predetermined driving condition, the second frictional clutch C2 of the dual-clutch 5 is engaged, and the fifth speed driving is changed to sixth speed driving. In the same manner, when the fifth shift stage is reset during the vehicle being driven at sixth speed, the seventh shift stage is established (refer to FIGS. 10F1 to 10F4). Then, when the vehicle condition changes to the predetermined driving condition, the first frictional clutch C1 of the dual-clutch 5 is engaged, and the sixth speed driving is changed to the seventh speed driving. So far, step-up operations, for shifting the shift stage of the transmission from neutral condition to the seventh shift stage, are described above. On the other hand, step-down operations, for shifting the shift stage of the transmission from the seventh shift stage to the neutral condition, may be performed in reverse order of the step-up operations.

In addition, in a case of the reverse driving, the controlling apparatus detects the outer plan surfaces E and G, of the first and second shifting members 30 and 35, which are formed with the stepped recessed-portions 31 and 36 respectively, in a position where the outer plan surface E of the first shifting member 30 is coplanar with the outer plan surface D of the retaining member 20, while the outer plan surface G of the second shifting member 35 is coplanar with the outer plan surface A of the retaining member 20, as illustrated in FIGS. 10G1 to 10G4, in the conditions where the engine of the vehicle is started, the first and second frictional clutches C1 and C2 of the dual-clutch 5 are disengaged, and further where the shifting apparatus for the transmission is retained at the base position. In such condition, when the retaining member 20 and the first and second shifting members 30 and 35 are downwardly moved with the predetermined distance S1, the driving pin 47a, which is retained in the neutral interlock groove 21d formed at the outer plan surface D of the retaining member 20, is moved in directions as indicated with a series of three arrows q8. Then, the reverse shift stage is formed by operating the fourth shifting clutch 8d via the fourth fork shaft 43. Afterward, the driving pin 47a enters into and is retained in the shifting interlock groove 22h formed at the outer plan surface D of the retaining member 20. In such condition, when the second frictional clutch C2 of the dual-clutch 5 is engaged by the operation of the controlling apparatus, the vehicle is started driving backward. On the other hand, when the second frictional clutch C2 is released, and further when the first and second shifting members 30 and 35 are detected in a position as illustrated in FIGS. 10H1 to H4, i.e., in a position where the outer plan surface E of the first shifting member 30 is arranged to be coplanar with the outer plan surface C of the retaining member 20 and the outer plan surface G of the second shifting member 35 is arranged to be coplanar with the outer plan surface D of the retaining member 20, and are upwardly moved with the predetermined distance S2, the driving pin 47a is moved in directions as indicated with a series of three arrows q9 and then, the reversing shift stage is reset and the vehicle stops driving backward.

In the first and second embodiments described above, when the retaining member 20 and the first and second shifting members 30 and 35 are moved and one of the driven pins 44a to 47a enters into the stepped recessed-portion 31 of the first retaining member 30 or enters into the stepped recessed-portion 36 of the second shifting member 35, another one of the other driven pins are always retained in the corresponding neutral interlock groove 21a to 21d, the shifting interlock groove 22a to 22h, the non-shifting groove 32 of the first shifting member 30, or the non-shifting groove 37 of the second shifting member 35. Therefore, even when an unexpected force is applied, only one shift fork, from among the first to fourth shift forks 40a to 43a, which is connected to the driving pin entering into the stepped recessed-portion 31 or 36 is moved and the other shift forks are not moved. Accordingly, unexpected double-engaging of the transmission is certainly prevented from being generated.

According to the first and second embodiments, each of the retaining member 20 and the first and second shifting members 30 and 35 is formed by the thick board members which includes the square shape in cross section. Further, the neutral interlock grooves 21a to 21d and the shifting interlock grooves 22a to 22h are linear grooves which are parallel with the axial line of the shift-and-select shaft 11 being inserted into the retaining member 20 at which the interlock grooves 21a to 21d and 22a to 22h are formed. In the same manner, the non-shifting grooves 32 of the first shifting member 30 and the non-shifting grooves 37 of the second shifting member 35 are linear grooves which are parallel with the axial line of the shift-and-select shaft 11 being inserted into the first and second shifting members 30 and 35. Accordingly, it may be extremely easier to manufacture the interlock grooves 21a to 21d and 22a to 22h of the retaining member 20 and the non-shifting grooves 32 and 37 of the first and second shifting members 30 and 35. Still further, each stepped recessed-portion 31 and 36 of the corresponding first and second shifting member 30 and 35 is a simple planar portion or a simple curved surface which is manufactured easily. Accordingly, it may be extremely easier to manufacture each stepped recessed-portion 31 and 36 of the corresponding first and second shifting member 30 and 35. Therefore, manufacturing cost for the shifting apparatus for the transmission may be reduced.

Further according to the first and second embodiments, each of the retaining member 20 and the first and second shifting members 30 and 35 includes square shape in basic cross section. Accordingly, it may be extremely easier to manufacture the retaining member 20 and the first and second shifting members 30 and 35, and cost for manufacturing the shifting apparatus for the transmission may be further reduced. However, the present invention is not limited as described above. Alternatively, the cross sectional shape of each of the retaining member 20 and the first and second shifting members 30 and 35 may be regular polygon such as regular pentagon and equilateral hexagon, or the like.

According to the first and second embodiments, four outer plan surfaces, of each of the retaining member 20 and the first and second shifting members 30 and 35, are utilized. However, the present invention is not limited as described above. In a case where the number of the shift stages is smaller, only two or three outer plan surfaces from among the four outer plan surfaces, which are parallel with the axial line of the shift-and-select shaft 11, of each of the retaining member 20 and the first and second shifting members 30 and 35 may be utilized.

Further according to the first and second embodiments, the first and second shifting members 30 and 35 are arranged at the both axial sides of the returning member 20, respectively. Therefore, two sets of the speed change gear is selectively shifted by means of the retaining member 20 and the first and second shifting members 30 and 35, and the cost for manufacturing the shifting apparatus for the transmission may be further reduced. However, the present invention is not limited as described above. In a case where the number of the shift stages is smaller, only one shifting member may be provided at one of the axial lateral sides of the retaining member 20.

Still further according to the first and second embodiments, the first and second shifting members 30 and 35 are detected in above-described positions and are reciprocated by the controlling apparatus for the shifting mechanism for the transmission. In addition, the frictional clutch 1 and the dual-clutch 5 are operated by the controlling apparatus for the shifting mechanism, respectively. Such operations are performed in accordance with the operating condition of the vehicle detected by the sensor, the operating condition which is represented by throttle opening angle, vehicle speed, or the like. However, the above-described operations may be performed manually.

Due to the above described shifting apparatus for the transmission, the selecting actuator P rotates the shifting apparatus, and the shifting members 30 and 35 are sequentially detected in a position where the outer plan surfaces thereof are coplanar with the outer plan surfaces of the retaining member 20. Then, the shifting actuator Q reciprocates the retaining member 20 and the first and second shifting members 30 and 35 upon the detected condition, so that the speed changing is performed. The driving pins 44a to 47a which are retained in the neutral interlock grooves 21a to 21d are reciprocated by the reciprocation of the retaining member 20 and the first and second shifting members 30 and 35. Then, one of the driving pins 44a to 47a, which is retained in one of the neutral interlock grooves 21a to 21d being continuous with the outer plan surfaces E, G with the stepped-recessed portions 31, 36, of the shifting members 30 and 35, makes a contact with either of the shifting inclined surface 31a or 36a respectively formed at stepped recessed-portions 31 and 36 of the corresponding shifting members 30 and 36, and is moved in a direction being perpendicular to the shift-and-select shaft 11 to a position where the driving pin faces the corresponding shifting interlock groove from among the shifting interlock grooves 22a to 22h of the retaining member 20. Accordingly, the shift fork is moved via the corresponding fork shaft, and the driving pin is retained in the corresponding shifting interlock groove by the reciprocation of the retaining member 20 and the shifting members 30 and 35. The other driving pins, which are retained in the other neutral interlock grooves being continuous with the non-shifting grooves 32 and 37 of the shifting members 30 and 35, are moved in the corresponding neutral interlock grooves of the shifting members 30 and 35 once, respectively. Then, the other driving pins are returned to and retained in the corresponding neutral interlock grooves of the retaining member 20 by the reciprocation of the retaining member 20 and the shifting members 30 and 35. The neutral interlock grooves 21a to 21d and the shifting interlock grooves 22a to 22h of the retaining member 20, and the non-shifting grooves 32 and 37 of the shifting members 30 and 35, are linear grooves which are parallel with the axial line of the retaining member 20 and the shifting members 30 and 35. Accordingly, it may be extremely easier to manufacture the interlock grooves 21a to 21d and 22a to 22h of the retaining member 20 and the non-shifting grooves 32 and 37 of the first and second shifting members 30 and 35. Still further, each stepped recessed-portion 31 and 36 of the corresponding first and second shifting member 30 and 35 is a simple planar portion or a simple curved surface which is manufactured easily. Accordingly, it may be extremely easier to manufacture each stepped recessed-portion 31 and 36 of the corresponding first and second shifting member 30 and 35. Therefore, the cost for manufacturing the shifting apparatus for the transmission may be reduced.

Further, due to the above-described shifting apparatus for the transmission, each retaining member 20 and the shifting members 30 and 35 includes a square shape in cross section.

Due to the above-described structure, the retaining member 20 and the shifting members 30 and 35 are manufactured much easier. Accordingly, the cost for manufacturing the shifting apparatus for the transmission is reduced.

Still further according to the above-described structure, each retaining member 20 and the shifting members 30 and 35 includes a square shape in cross section thereof.

Due to the above-described structure, the retaining member 20 and the shifting members 30 and 35 are manufactured much easier. Accordingly, the cost for manufacturing the shifting apparatus for the vehicle is reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A shifting apparatus for a transmission having a plurality of rotational shafts, a plurality of sets of speed change gears mounted on the rotational shafts, a shift fork movable in parallel with the rotational shafts, a sleeve arranged between the adjacent sets of speed change gears and operated by the shift fork to connect one of the adjacent sets of speed change gears with the corresponding rotational shaft, so that a driving force transmitting path is established in the transmission with one of the sets of speed change gears selectively shifted in response to a movement of the shift fork and the operation of the sleeve, the shifting apparatus comprising:
a shift-and-select shaft supported by a supporting member and arranged in perpendicular with the rotational shafts of the transmission, the shift-and-select shaft being rotatable by an actuation of a selecting actuator and reciprocable in an axial direction by an actuation of a shifting actuator;
a retaining member formed by a board member with a regular polygon in cross section, the board member having a plurality of outer plan surfaces being parallel with an axial line of the shift-and-select shaft, the retaining member coaxially and rotatably supported by the shift-and-select shaft and to be limitedly slidable in the axial direction, the retaining member being arranged to be restricted from a relative rotation with the supporting member;
at least one shifting member formed by a board member with a regular polygon in cross section being identical with the regular polygon in the cross section of the retaining member, the board member having a plurality of outer plan surfaces being parallel with the axial line of the shift-and-select shaft, the shifting member fixedly supported by the shift-and-select shaft to be rotatable and slidable therewith and to be in contact with an axial end surface of the retaining member;
a plurality of driving pins connected to the plurality of shift forks, respectively, for moving the plurality of shift forks in a direction being parallel with the plurality of rotating shafts of the transmission;
a plurality of neutral interlock grooves formed to be slidably engaged with the plurality of driving pins, the plurality of neutral interlock grooves formed at intermediate portions of the outer plan surfaces of the retaining member, respectively, the neutral interlock grooves extending over an entire length in a thickness direction of the retaining member to be in parallel with the axial line of the shift-and-select shaft;
a plurality of shifting interlock grooves formed adjacent to the plurality of neutral interlock grooves respectively, with a predetermined distance, the shifting interlock grooves extending over the entire length in the thickness direction of the retaining member to be in parallel with the axial line of the shift-and-select shaft, a shape of the shifting interlock grooves being identical with a shape of the neutral interlock grooves, respectively;
a stepped recessed-portion formed at one of the outer plan surface of the shifting member, the stepped recessed-portion including a shifting inclined surface facing the axial end surface of the retaining member, the shifting inclined surface inclining relative to the axial end surface of the retaining member in a radial direction; and
a plurality of non-shifting grooves formed at the other outer plan surfaces of the shifting member, the plurality of non-shifting grooves being arranged to be continuous with the neutral interlock grooves and shifting interlock grooves of the retaining member, when the shifting member is arranged to be coplanar with the outer plan surfaces of the retaining member,
wherein the shifting member is rotated by the selecting actuator via the shift-and-select shaft and is sequentially detected in a position where the outer plan surfaces of the shifting member are arranged to be coplanar with the outer plan surfaces of the retaining member respectively, the retaining member and the shifting member are reciprocated in the axial direction by the shifting actuator via the shift-and-select shaft upon a detected condition, the plural sets of speed change gears are selectively shifted by retaining the driving pin retained in the neutral interlock groove facing the outer plan surface of the shifting member formed with the stepped-recessed portion in the shifting interlock groove of the retaining member after contacting the driving pin with the shifting inclined surface of the stepped recessed-portion and moving the driving pin with the corresponding shift fork.

2. A shifting apparatus for a transmission according to claim 1, wherein each retaining member and the shifting member includes a square shape in cross section.

3. A shifting apparatus for a transmission according to claim 1, wherein two shifting members are provided at both axial sides of the retaining member.

4. A shifting apparatus for a transmission according to claim 2, wherein two shifting members are provided at the both axial sides of the retaining member.
